(19) United States
(12) Patent Application Publication
(10) Pub. No.: US 2011/0274275 A1
(43) Pub. Date: Nov. 10, 2011

(54) Trans-Security Components System and Methods

(76) Inventor: Maria Estela Seitz, Tampa, FL (US)

(21) Appl. No.: 13/144,115

(22) PCT Filed: Aug. 25, 2010
(86) PCT No.: PCT/US10/46714

§ 371 Date: Jul. 12, 2011

Related U.S. Application Data
(60) Provisional application No. 61/236,673, filed on Aug. 25, 2009.
(60) Provisional application No. 61/236,579, filed on Aug. 25, 2009.

(51) Int. Cl. H04W 12/06; G06K 19/16; G06K 19/077

(52) U.S. Cl. 380/270; 235/492

(57) ABSTRACT

A system of combating the shipment of contraband goods is described. After products are ordered, custom made secure tags are created. Corresponding data is created at a central database. The tags include encrypted information about the tag, the products and the mode of shipping. The tags can be placed at several locations from inside the goods to attached to the outside of the shipping container. The encryption and other measures are used to prevent the unauthorized duplication of the tags. As the goods make there way through the distribution channels the goods can be scanned at convenient locations. The encryption scheme can be altered by reference to time. The scanner is connected to the database and can receive the proper encryption scheme will automatically and at random be remotely changed every few minutes. The scanning of the goods will reveal whether unauthorized goods are present in the shipment.

### CROSS-REFERENCE TO RELATED APPLICATION

This application claims priority to U.S. Provisional Application Ser. No. 61/236,673, filed Aug. 25, 2009, and to U.S. Provisional Application Ser. No. 61/236,579, filed Aug. 25, 2009. The contents of both applications are incorporated herein by reference.

### BACKGROUND OF THE INVENTION

The subject invention is directed to transfer security components, systems and methods. More particularly the invention is directed to combat the international conversion of goods and materials and to dynamically track and verify shipments of goods and materials in a controlled manner to which only authorized persons have access.

Conventional inventory control methods are built on platforms that support the Gen 2 RFID standard. This standard, based on open architecture, was based on a consensus from more than 60 technology companies and government agencies worldwide. It combines RFID technology, the Internet, and electronic product codes. Inventory control systems based on this standard are designed to provide cost-efficient and accurate tracking information throughout supply chains. Products having an “RFID tag” can be quickly scanned with the tracking data delivered world wide via the interne.

What conventional inventory control methods and systems do not do, however, is provide security against those who would misuse the system. The problem is somewhat analogous to that of open architecture computer software, which benefits software developers and users but offers little protection against software piracy or the spread of computer viruses. So too the Gen 2 RFID based inventory systems aid legitimate users but do not protect against an unauthorized appropriation. For example, using the Gen 2 RFID standard, one can replace a legitimate shipping container with an empty one having an identical RFID tag. The conventional system will be unable to detect the switch until the container is opened.

Prior art RFID readers are typically installed under point-of-sale counters, behind walls or on ceilings—providing a method for item-level tracking, retail inventory management, file tracking and asset management applications in environments. Conventional SKU numbers support warehouse operations. The system disclosed herein can enhance or replace these RFID readers and conventional SKU numbers. The system can also be used in combination with stock-keeping unit (SKU) numbers of a client as necessary or desirable.

Just as anti-copying measures and antivirus programs protect against unauthorized uses of computer software, the disclosed components, systems and methods provide a measure of security for the users of the world-wide shipping systems.

The present invention, however, provides additional security not present in existing tracking methods used by courier services (Fedex, UPS, U.S. Post Office, etc.) and other tracking devices.

The present invention enhances inventory management and warehouse operations by providing a secure tracking system through domestic and global channels of distribution and modes of transport.

In addition, the present invention provides law enforcement at all designated official ports with a way to identify counterfeit cargo in seconds and other unauthorized traffic using a tag-like component that is embedded within a product or a shipment.

The components, systems and methods of the subject invention preferably include a security component(s) such as a thread, tape, strip, patch, film, or the like, comprising an encryption system that utilizes a unique combination of radio frequency identification (RFID), stock-keeping unit (SKU) system and an encryption code. The encryption code is preferably readable by use of either a laser or a re-programmable antenna reader. The use of this system is intended for, but not limited to, law enforcement and customs control purposes, enhanced security, and heightened inventory control.

The security component is capable of being imbedded or incorporated within most commodities, such as for example, the sole of a shoe, the fabric of a garment, the wall of a plastic or glass bottle; affixed to commodities' individual container(s); or affixed to an outer container housing individual containers.

Subscribers to the security system would typically be required to upload data into a secure data base with dedicated server(s). Uploaded data would contain information normally found on a customs entry document, which information is not conventionally fully transferred into a cargo manifest in its totality, such as, shipping information, consignee, description of goods, weight, value, country of origin, point of lading, and point of unlading, bill of lading/airway bill information, etc.

The security component information can be securely captured at points of departure from, and arrival into, a customs installation, a shipping warehouse, or other locations as the commodities pass through prescribed channels of transportation, distribution, and also passing through laser reader(s) or antenna(s) in customs ports. Immediate analysis and verification of the legitimacy of the shipment occurs as a direct result of subject security component tracking capacity combined with the present invention's servers capabilities and the present invention system's software and hardware given to a subscriber and his channels of transportation and distribution.

The components and methods disclosed herein contribute uniquely identifiable and valuable information to security, anti-counterfeit and other applications.

The products and methods preferably comprise a material such as a thread, tape, strip, patch, film, or the like, with encoded particles and an encryption system that utilizes a unique combination of encryption codes chosen at random by programming software at a central database. The software is pre-programmed to remotely and at random, change the combination of encryption codes stored in the database every few minutes or other appropriate time period. Each of the encryption codes retain compatibility or ability to be used in combination with an existing set of a user's radio frequency identification (RFID), stock-keeping unit (SKU) codes and system. Each current (that is, each time it is remotely changed by secure central database) encryption code, is readable by use of a re-programmable laser or other re-programmable optical scanner or a re-programmable antenna reader. The use of the components, systems, and method are intended for, but not limited to enhanced security and heightened inventory control.

The products, system and methods disclosed herein are designed for compatibility after very minor adjustments and training with existing databases, software and processes in the 27 member countries of the European Union, for example, so that when established in said countries and working in tandem with U.S. Customs, a Transatlantic Security Zone may be established.

### BRIEF DESCRIPTION OF THE DRAWINGS

Turning now to the drawings wherein like numerals indicate like parts and/or system components:

FIG. 1 is a schematic view of a system in accordance with a preferred embodiment of the invention providing for enhanced monitoring and security control;

FIG. 2 is a plan view of a security tape in accordance with one embodiment of the invention;

FIG. 3 is a plan view of a security tape with an application of a security hologram;

FIG. 4 is an axonometric broken away view that discloses structural layers of the security components disclosed in FIGS. 2 and 3;

FIG. 5 is a plan view of a security thread component in accordance with one embodiment of the invention;

FIG. 6 is a plan view of the thread security component disclosed in FIG. 5;

FIG. 7 is a schematic view of interrelated steps in accordance with the security system of the present invention;

FIG. 8 is a pictorial view of an entrance/exit station for cargo within an intermodal container entering or exiting a shipyard; and

FIG. 9 is a second pictorial view of a portal monitoring station where trucks pass through at a typical sea port.

FIG. 10 is a flow diagram illustratively showing steps in a method of using the trans security system from ordering the tags to reading the results of scans.

FIG. 11 is a second flow diagram illustratively showing steps in a method of using the trans security system and expanding the decryption scheme operating at the Scan Tagged Product(s) step of FIG. 10.

FIG. 12 is a third flow diagram illustratively showing steps in a method of using the trans security system and expanding the comparison step of FIG. 10.

### DETAILED DESCRIPTION OF THE INVENTION

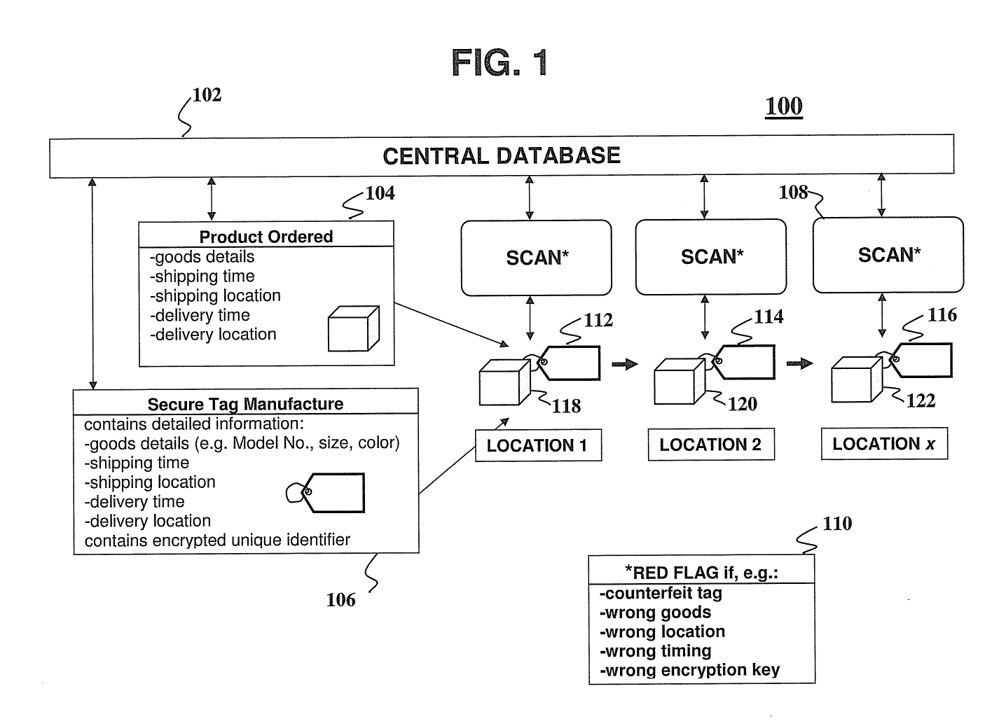

FIG. 1 illustrates a simplified overview of the subject security system 100 including a central database 102, data 104 associated with the product order, secure tags 106, scanning of the tags 108 and the “Flags” 110 generated by the scanning process.

Product Order. When a buyer and seller agree to a product order 104, generally speaking, the order specifies details about the goods such as the amount of goods ordered, the price, product(s) serial numbers, model numbers, size, color etc. Usually, the order will specify certain shipping details, such as the time and place of a port from which the goods are shipped and the time and place of delivery to a destination port. These details will be transmitted to and stored in a central database 102 at the same time that they are transmitted to the factory.

Secure Tag Manufacture. After the products are ordered and the order details are stored in the central database 102, secure tags can be manufactured 106. In a simple embodiment, the tags are manufactured to contain encoded unique identifiers, such as an encoded serial number. In a more elaborate embodiment, illustrated in FIG. 1, the tag contains not only the unique identifiers, but also goods details and shipping details. The unique identifier and other information stored on the tag may be encrypted using, for example, a standard, time-dependent, or time-varying encryption method. The information contained on the tag is also uploaded to the central database 102.

Next, tags are sent to the factory, manufacturing location, or other location or facility where the goods are produced, and the tags 112, 114, 166, etc. are attached to or imbedded within goods 118, 120, 122, etc., respectively. A record of the corresponding transaction is uploaded to the central database 102 in real time as each specific tag is permanently associated with the specific product to which the tag is attached. The tag is also associated with all of the product order data, including not only the goods details but the shipping details. This association is generally carried out by way of scanning the products 108 before (and as a check after) the tag is attached to the product. A special reprogrammable scanner is used that has a communication link to the central database 102.

Note while it is logistically easier to wait to associate each tag with each product after the tag is attached to the product, it can be better, for security reasons, to associate the product with the tag when the tag is manufactured. In this way, no one at the factory can add counterfeit goods into the supply chain. This is because each tag is “earmarked” for a particular good. If counterfeit goods are introduced at the factory, the factory will prematurely run out of tags, thus triggering an audit.

Scanning. Once the products are tagged, the products can now be scanned at convenient locations 108 as they make their way through the various stops in a supply chain. As each scan is carried out, the scanning location and scanned time can be compared to the information in the central database 102. If the actual time and location is inconsistent with that expected from the information stored in the database, the database can sent a “red flag” 110 to the scanning location. If the information is consistent, a “green flag” can be sent. Also, if the shipment includes multiple tagged goods, the scanning may identify all of the goods included in the shipment and serve as a quick inventory check as the database knows the correct number and identity of the products that should be in the shipment. If the inventory resulting from the scan is inconsistent with the expected inventory, an audiovisual “red flag” can be sent.

Once a shipment is “red flagged,” officials or others with high level access to the database, can be called to investigate. Using their high level access rights, the officials can quickly download the expected inventory from the central database, compare it to the actual inventory and determine whether any discrepancy is a result of fraud or error.

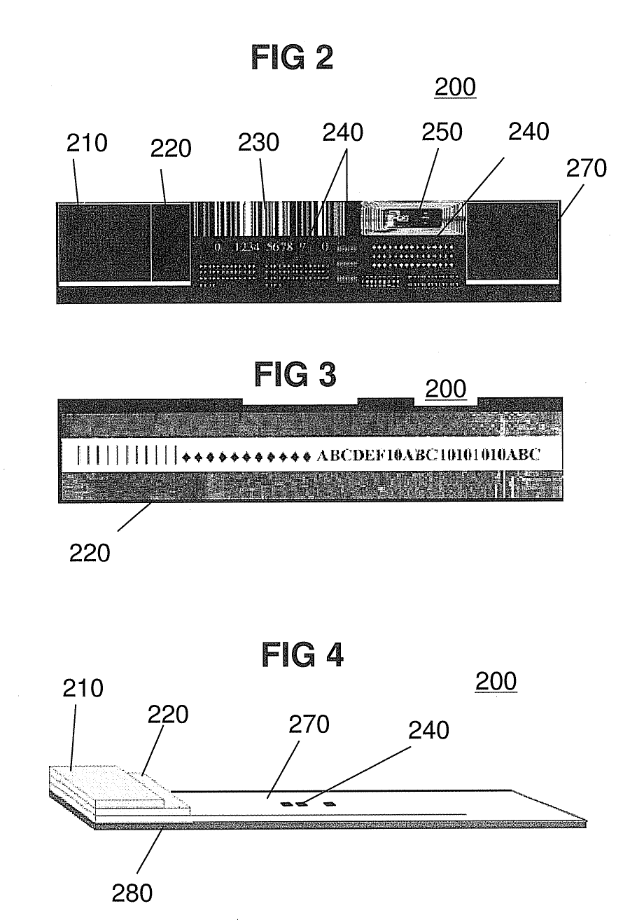

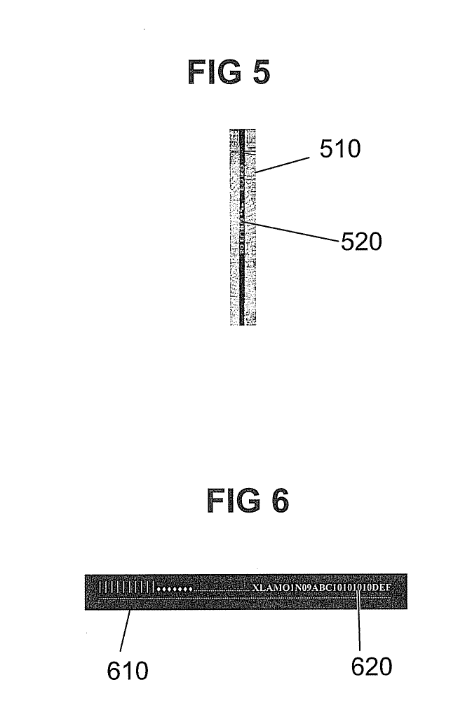

FIG. 2 illustrates a plan view of a security tag 200. The tag has an outer product material 210 made with a durable material such as leather, cloth, or a clear polymer. The tag has a cover 220 which can be a hologram or some other material that is difficult to copy. The cover 220 can also contain encrypted information. The tag further comprises a radio frequency identification (RFID) code 250. This code can be encrypted as a first encrypted code. The tag can also include information readable by a reprogrammable laser scanner or other reprogrammable optical technology, such as an SKU Code. Like the RFID code, the SKU code can also be encrypted as, e.g., a second encrypted code. Finally the tag can include abed material 270 into which particles 240 are embedded. The size and distribution pattern of the embedded particles is hidden from view by the cover 220. These particles, together with their specific size and layout make up a third encrypted code or unique identifier.

FIG. 3 illustrates a holographic cover 220 for the security tag 200. The hologram may contain a steganographic code which may be, at random times a very small part of the code or also, at random, purely a distraction to make a counterfeiter believe that this steganographic image contains the only code that identifies the product as genuine when the code is really imbedded or contained elsewhere, said code being able to be remotely or automatically changed every few minutes. For instance, in order to crack a five dimensional code (5D) encryption code used in a device imbedded in a product in accordance with the present invention, such as shoes or other goods, a counterfeiter would have to destroy the product to copy the code and then it serves them no purpose as the code changes every few minutes.

FIG. 4 is a partially broken away oblique view of the security tag 200 illustrating application of a durable outer material 210, a cover 220, particles 240 used for constructing the code and a bed 270 into which the particles 240 are embedded. Also shown in FIG. 4 is the base 280 upon which the other tag components are constructed.

The bed materials 270 is preferably composed of a BASF polymer such as BASF 1175 A 10 W compound having the characteristics as shown in the following table:

TABLE 1

| | Typical Value | |
|---|---|---|
| Properties | English | SI |
| Physical | | |

| | | | |
|---|---|---|---|
| Specific Gravity | gr./cm³ | 1.14 | 1.14 |
| Hardness | Shore A | 75 A | 75 A |
| Flame Rating | | V0-.036°, | V0-0.9 mm, |
| | | V2-.060° | V2- |
| LOI | % | 23% | 23% |

Mechanical

| | | | |
|---|---|---|---|
| Tensile Strength | psi/MPa | 6000 psi | 41 MPa |
| (Ultimate) | | | |
| Tensile Stress | @ 100% Elong. | 700 psi | 4.8 MPa |
| Tensile Stress | @ 300% Elong. | 1550 psi | 11 MPa |
| Elongation at Break | % | 685% | 685% |
| Tensile Set | % | 51% | 51% |
| Compression Set, % | 22 hrs @ 23° C. | 20% | 20% |
| Compression Set, % | 22 hrs @ 70° C. | 45% | 45% |
| Flexural Modulus | psi/MPa | 3600 psi | 25 MPa |
| Tear Strength | lb/in. N/mm | 325 lb/in. | 57 N/mm |
| Taber Abrasion | 1000 gr./H-18 | 20 mg | 20 mg |
| Resistance/mg loss | | | |
| Thermal | | | |
| Vicat Softening Point | ° F./° C. | 196° F. | 91° C. |
| Glass Transition | ° F./° C. | −53° F. | −47° C. |
| Temperature | | | |

Of these characteristics, the abrasion, shore hardness, tensile strength, and elongation are particularly significant to the function and performance of the subject invention. We note that material characteristics may vary from those shown in Table 1. For example, the bed may be formed of a flexible material having a tensile strength of between 40 MPa and 50 MPa; and having a hardness of between 65 to 96 measured on a shore A hardness scale.

In addition to the bed material, the imbedded particles 240 are composed of a BASF C 60 D 53 composition with the characteristics shown in Table 2 below:

TABLE 2

| Physical property | | Unit | Value |
|---|---|---|---|
| Hardness | | Shore D | 60 |
| Density | | g/cm³ | 1.23 |
| Tensile Strength | | MPa | 50 |
| Elongation at break | | % | 450 |
| Stress at 20% elongation | | MPa | 10 |
| Stress at 100% elongation | | MPa | 20 |
| Stress at 300% elongation | | MPa | 35 |
| Modulus of elasticity-tensile test | | MPa | 330 |
| Tear strength | | N/mm | 180 |
| Abrasion loss | | mm³ | 20 |
| Compression set at room temperature | | % | 40 |
| Compression set at 70° C. | | % | 50 |
| Tensile strength after storage in water | | MPa | 43 |
| at 80° C. for 21 days | | | |
| Elongation at break after storage in water | | % | 450 |
| at 80° C. for 21 days | | | |
| Notched impact strength (Charpy) | +23° C. | kJ/m² | No break |
| | −30° C. | | 5 |

Similarly, the embedded particles 240 having the designated characteristics of shore hardness, tensile strength, and elongation are of particular significance for the function of the subject security tag 200. For example, the characteristics of the material used as embedded particles 240 may vary from those shown in Table 2, and have a tensile strength greater than that of the bed material. The characteristics of the bed material and embedded particles may be essential to protect the RFID tag, including an RFID antenna and RFID chip, which in some embodiments may be embedded within the bed material.

In alternate embodiments, the components of the security tag 200 may be miniaturized into a thread, which will contain the same SKU, RFID and encoded data and encryption codes which may be remotely changed at random every few minutes in coordination with the central database.

Table 2 is a chart that illustrates and details preferred specifications for one embodiment of material to use for encoded magnetized or non magnetic particles to be imbedded in the security strip, which bed is also made of preferred materials which were designed specifically for their resistance to force of impact, elongation, and tensile strength.

Table 1 is a chart that illustrates and details preferred specifications for one embodiment of the bed material for the security strip which material is capable of protecting the signal encoded magnetic or non magnetic particles made from the material of Table 2 imbedded therein, from water, alcohol, oil, etc., as well as providing security from scratches or other damage in transit when affixed to inside of boxes, cartons or inside various types of container bolt seals.

During product production, one side of a two-sided production line scans a code contained in the security strip onto software and the reprogrammable scanner sends the same information to the central database to store a record of what is being done, where, when and by whom. A second side of a two-sided production line checks the actions of the first side to ensure all was done correctly. If at any point, this does not match or is in excess of what the authorized user identified in the product order details 104 and stored in the central database, a program running on a central server connected to the central database will automatically issue an audiovisual alarm or “Red Flag”.

The realized security system can be advantageously used with different types of products and their different type of containers, like shoe boxes for shoes, plastic or glass containers for cosmetics, pharmaceutical or hygiene products, gifts bearing trademarks, etc., which boxes will contain a tag containing encrypted five dimensional (5D) and remotely changeable code of the item(s) or product inside, amount, type, size, weight, etc. plus the name of the person doing the scanning.

The boxes can be put in a small pallet to be scanned and then placed inside a carton. A person in the last row of the production line will take the items from the mini pallet, scan them with a reprogrammable security scanner (a reprogrammable “decryption scanner”) and then scan an especially outward color coded carton tag. The security scanner will then wirelessly send the information to the central database in an encrypted five dimensional (5D) and remotely changeable code (which can only be remotely changed from the central database or central server) code. The result of this action is that the scanner immediately receives a programming signal from the central database which allows it to encode the especially outward color coded carton tag, giving an audiovisual signal when this is complete. A worker may then imbed the color coded carton tag to the lower inside corner of the carton and then load the items from the mini pallet into the carton and seal it. At this point, the color coded tag imbedded in the carton contains the ID (number) of the carton as well as the ID of all the item(s), boxes and/or product(s) inside the carton, amount, type, size, weight, etc. of all of these plus the name of the person doing the scanning.

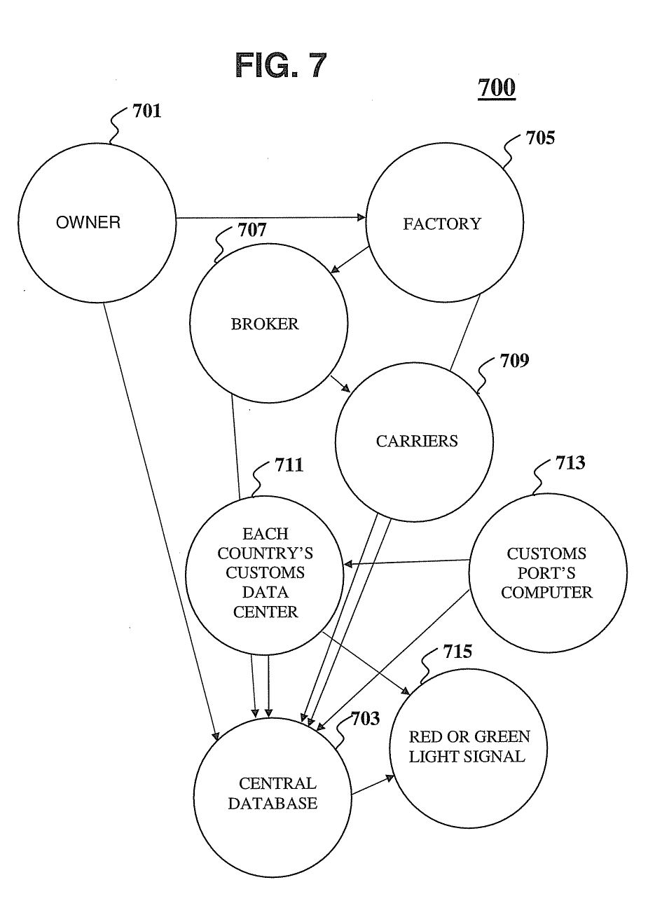

FIG. 7 is a block diagram 700 illustratively showing data paths of encoded data flows as can be programmed in the system. When an owner 701 of the good to be produced, manufactured, and/or shipped receives an order, the owner creates the product and shipping data and transmits this data to the central database 703 at every step of production, packing and shipping. The owner also transmits this data to the factory 705 where the products will be manufactured. The factory 705 attaches the security tag to the product and transmits the data to the central database 703. In a preferred embodiment, the factory can also work with a broker 707 or freight forwarder. The broker is a middleman specialist experienced in working as a go-between factories 705, common carriers 709 and various country's customs offices 711. The broker will, as necessary, transmit the appropriate data from the factory to the central database, the common carrier and to the data center of a country's customs offices 711 as shown in FIG. 7.

The common carrier 709 will, at designated times, transmit data to the central database. When the common carrier brings a shipment to a customs port, the common carrier will transmit data to a computer at the port 713 which, in turn, will transmit the data to and to a country's office data center 711, as shown in FIG. 7.

At various designated times, a comparison is made between the data collected at the country's customs data center 711 and the data collected at the central database 703. When the data is consistent, a “Green Light” signal is generated. When the data is inconsistent, a “Red Light” signal is generated. The signal 715 is then transmitted to the appropriate destination. For example, when a shipment arrives at a customs port customs and is scanned, the Green Light/Red Light signal 715 can be transmitted to the customs port where the shipment was scanned.

Several types of portal monitors can be used, including encryption scanners which may be located at arrival to loading docks, yards and/or ports, which is the typical location of the re-programmable scanner, reader or re-programmable reader of the existing security material to detect WMD's or radioactive material at a portal monitor of a customs yard and at which portal monitor columns is where typically the subject scanner and part of the trans security system will be placed, without interfering with the normal US customs security scanners. After passing customs scanners and the subject reprogrammable scanner, a customs seal is applied.

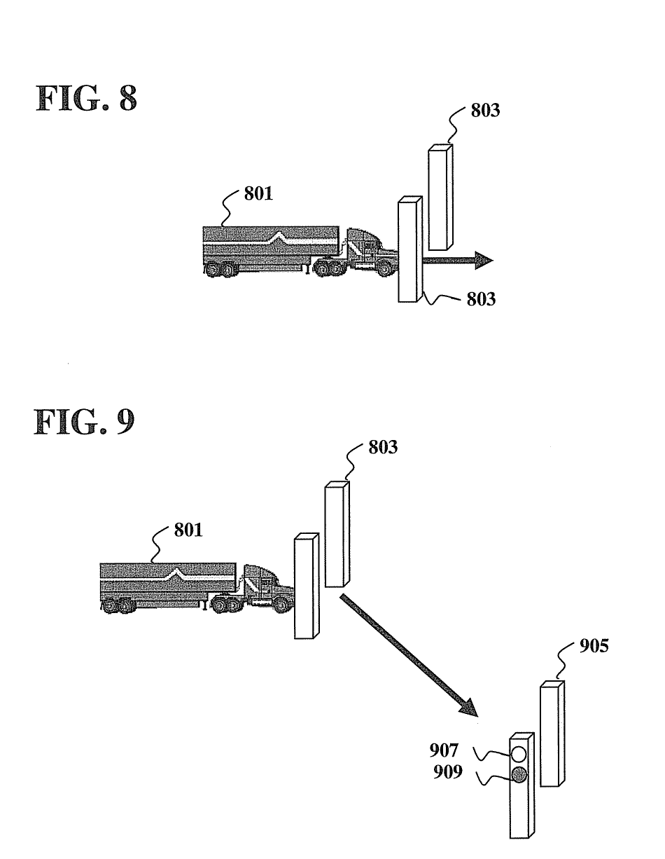

FIGS. 8 and 9 illustrate a truck 801 approaching the portal monitors 803 and illustrates the view of the normal minimum distance between portal monitors (to comply with Hazmat requirements due possible contamination if radioactivity is found) and point of final egress 905. FIG. 9 also illustrates that during the time the truck bearing the container(s) reaches the point of egress 905 (“last checkpoint” for US Customs to inspect something), the Egress Point Customs Official will have received a red 909 or green 907 audiovisual signal whether or not the contents are counterfeit, the point of egress being the “last checkpoint” of commercial shipments leaving an air, sea, land or rail port yard exit gate (point of egress).

FIG. 9 also illustrates the view at a “Final Checkpoint” or Egress Point 905. If there should be a distracted officer or any kind of event at this egress point and the signal from the central database comes back with a “red” signal 909 whether or not anyone tries to bypass the system to allow the shipment to exit, the program from the central database working with the software belonging to this system and installed in the customs computer will automatically lock the gate 905 and issue aloud, audiovisual, system wide alarm to the local network with a softer audiovisual signal to the entire customs local as well as to an operator of the central database, which will take steps to ensure adequate action by customs to seize a shipment if counterfeit.

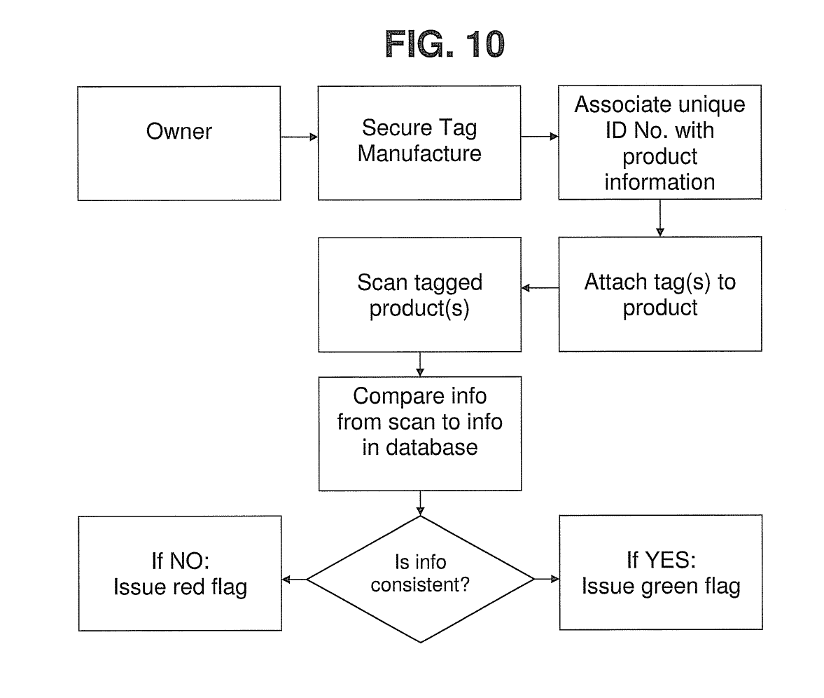

FIG. 10 illustrates an embodiment of the system described in the block diagram of FIG. 1. FIG. 10 shows the steps of the IP owner ordering the secure tags, the association of the tags with the IP owner's products, the scanning of the tagged products and the comparison of the scanned data with that found in the central database.

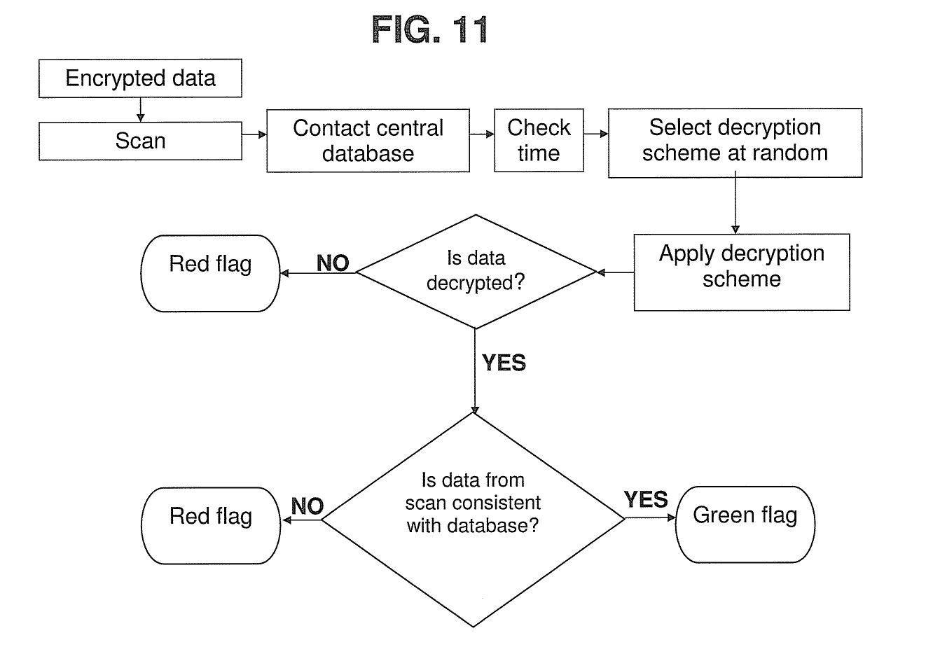

FIG. 11 expands Scanning step from FIG. 10. The system can be made secure from tampering by frequently changing the scheme by which the data is decrypted. An unauthorized user would have no way of knowing the decryption scheme currently in use. As shown in FIG. 11, after the tag is scanned the current time is checked and the time is used to select a decryption scheme. The scheme is applied to the scanned data. If the proper scheme is not used, the scanned data will not be properly decrypted.

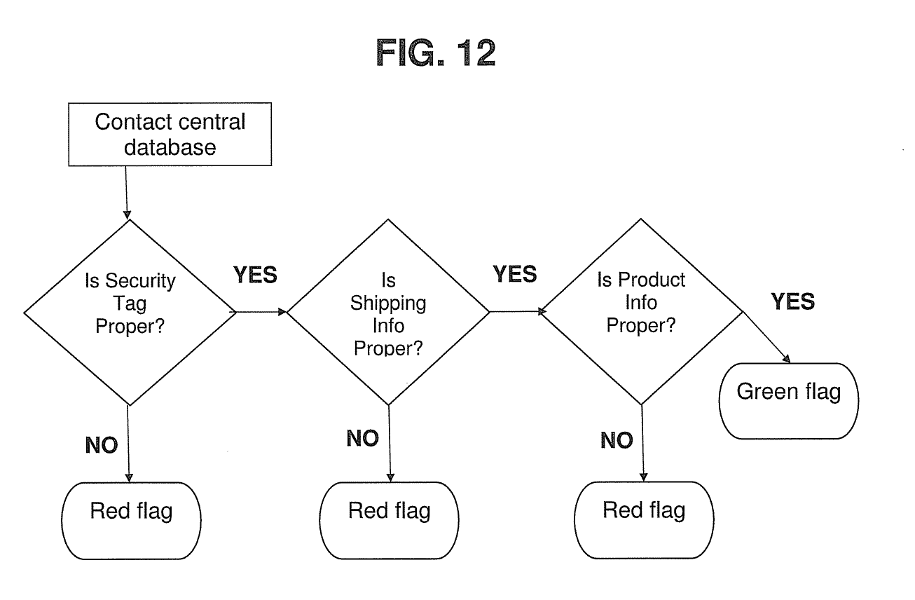

FIG. 12 expands on the comparison step illustrated in FIG. 10. As shown in FIG. 12, one can compare the scanned data with the data present on the database. There are at least three (3) different kinds of data to compare. First, one can determine whether the proper the information appears on the secure tag. This comparison reveals unauthorized duplication of the tag. Second, one can review the shipping information. This can reveal a scanned shipment showing up at the wrong port. This is typically the result of unauthorized removal of a tag from its original shipping container and transferred to another. Finally, the scanned data on the contents of the shipment can reveal whether some products have been taken from the shipment without authorization or whether some non-authorized products have been added to the shipment.

In brief sum, a preferred embodiment of the trans-security system originally created to prevent counterfeit items from entering a country and which can be used for other applications, that contains the following components:

a) an encrypted, remotely changeable tag with signal encoding of magnetic or non magnetic particles using a combination of known cryptology, and a novel five-dimensional (5D) set of mathematical and other codes which can be remotely changed every few minutes and is compatible with RFID and SKU,

b) a reprogrammable tag reader which may be in the form of a hand-held or stationary re-programmable scanner,

c) a control system with a secure set of firewalls;

d) a control system for any given product's channels of distribution (which means that if there is any corruption at any given point, the culprit will identify himself within seconds); and

e) a secure central database with which the reader is in communication.

A significant component of the security tag or security material is a remotely changeable code in an imbedded matrix which remotely changeable code, is compatible with RFID and SKU methods, yet each time the code is changed, involves a novel methodology using the most basic, rudimentary principles of quantum physics, regarding time and randomness combined with proven, true mathematical equations in a novel five-dimensional (5D) code that also contains any one of or a combination of military type cryptology, signal encoding, Intaglio printing, Watermarks, Security threads, See-through register, Special foil/special foil elements, Iridescent stripes with shifting colors, 1D or 2D Chebyshev Function, 2D or 3D Lissajous FFP motion, 2D Ideal Particle System Functions for 1D FFP Motion, spatial or any other type of encoding or encryption to be imbedded with or in said matrix in products, product boxes, cartons and/or containers. Again all of these codes, alone or in a combination thereof can be remotely changed by the central database operator at will. The system is designed to work with (or without) RFID and SKU with reprogrammable readers, scanners, certain other devices and hardware, all using advance-adjustable programming and which system enhances national security, law enforcement activities and prevents counterfeit copies of most any item from entering the US or other countries. The RFID and SKU (which are for the use of the Intellectual property owner) remain the same while the combination of the security system encryption codes, which combination is chosen and remotely changed at random by the program in the central database of the trans-security system every few minutes.

FIG. 11 illustrates a method by which decryption schemes are selected.

Subscribers to the security system would be required to upload data into a secure data base which is dedicated to the security system's own server(s). Uploaded data would contain information normally found on an entry documents, such as, shippers information, ultimate consignee, description of goods, weight, value, country of origin, point of lading, and point of unlading, bill of lading/airway bill information, and other information.

The security tag contains all previous data for contents and placed on the outside of a shipping container. The tags are preferably placed in the same location as the container customs seals and can even be integrated with the container seal. The tag can be encoded with data and affixed to the shipping container at the same time as the container seals are applied. The tag can be integrated beneath the surface of customs bolt seals so that the tags cannot be scratched or otherwise damaged in transit.

The security material stores the data in any number of ways. The data can be embossed in the surface, in the form of raised numbers or symbols that extend above the plane of the security material but for security reasons and to preserve the integrity of the data (so it cannot be scraped, scratched, or otherwise compromised), the raised signal encoded magnetic or non magnetic particles made of the specifications detailed in table 2 (which material may be selected to be extremely resistant to impact and scratches) are then imbedded in the special material with the specifications described in table 1 which material is extremely flexible.

A client workstation is configured with standard internet browser application (such as Safari, Netscape, MS Internet Explorer etc.) to access a customized web page. The web page is developed to utilize the primary language of the client. The worldwide open communication network is used to transmit message packets between the client workstation and the security system's communication server. The security system communication server monitors and controls access to the system intranet. Firewall and security applications are applied at this stage. The security system intranet configuration, combined with proprietary programming to ensure security, is the corporate network backbone for internal message packets and validated external message packets.

The security system application server can host certain web pages for clients and can use a client software package to validate authorized logins. The application server provides the development platform for internal and external requires summary reports.

The data storage server is the host of the tables, views, and login permissions. Various login permissions include READ, SELECT, WRITE, TIME, LOCATION, CODE and UPDATE. The operator of the database can also do that and much more.

The security material information would be captured at points of egress in departure and arrival locations, as the commodities pass through the prescribed reprogrammable laser reader(s) or reprogrammable RFID reader antenna(s) (or other reprogrammable decryption scanner), as illustratively shown in FIG. 9. Immediate analysis and verification of the legitimacy of the shipment would occur as a direct result of this security material's tracking abilities.

In operation, an owner of the goods to be manufactured and/or shipped determines the proper product codes, e.g. SKU and RFID codes and transmits this information to the factory where the products are being finished and simultaneously to the central database server location. Next, the entry document (of which cargo manifest data is a simple example) can be collected directly from the source and later confirmed indirectly from a broker. These data can then be used to encode the security material. The server collects additional data as the tags goods make their way through the various intermediate stops along the shipping route as the tagged goods are scanned using the detectors located at these various intermediate stops. The server then remotely changes the data on the tags to include all these changes, at each step. For example, a scan at the Customs and Border Protection (CBP) port will generate data which will be uploaded into the system as illustrated.

After the data is received, in this example from the customs and border protection port, the port computers will receive a “green” or “red” signal, indicating whether the shipment is authorized or unauthorized, respectively, as is illustrated in the figures. It will be extremely difficult to “fool” the security system at this point. The system will be able to instantly verify not only the product information, but also the entry document data. Thus, even if a counterfeit shipment contained the expected product codes, the shipment would still be flagged if it appeared at the wrong time, wrong place, or directed to a wrong destination.

The goods are identifiable through a combination of encryption codes, chosen at random by the server and remotely changeable, also at random, every few minutes, each time employing a different and unique combination of mathematical and cryptology equations, five dimensional (5D) codes based on quantum physics principles including the elements of randomness and time, and signal encoded magnetic or non magnetic particles, which combination of encrypted codes can also be used in combination RFID number and SKU number. This would mostly be to not disrupt an owner's processes for inventory control, etc. The subject invention will enhance an owner's capabilities to the extent of identifying counterfeit products by non authorized or non licensed distributors. The material is capable of being read by either a laser or antenna associated with a decryption scanner of the invention.

The information on the security material will be uploaded into a secure data network server by the party causing the international transaction to happen. The uploaded data will also contain the customs entry document and verify that the same uploaded data is also on the manifest information described above, such as the shipper's information, the importer of record, a description of the goods, quantities, value, weight, port of lading, country of origin and port of unlading at each stop and port or place of final destination.

Upon arrival into any intermediate stop utilizing this system, whether it is via land, air or sea, the commodities will pass through an egress point equipped with a prescribed antenna(e) or laser reader(s) such as the subject decryption scanner. Those egress points will be staffed and monitored by Customs personnel. The antenna or laser will read the material and the system will conduct an immediate analysis of the data captured, to verify the legitimacy of the shipment to Customs personnel, through the systems tracking abilities at the Customs Headquarters server. The extraction of data to the Customs server is a one-way process, meaning that no information from the Customs server may be accessed by users of the system. An example of monitors in place at these egress points is illustrated in FIG. 9. The portal monitoring devices currently in use contain radiation detectors and X-ray scanners. The columns where these monitoring devices are installed are the ideal place to also install the stationary scanners as the scanners may not emit any disruptive signals and are programmed to only read code and detect the encoded signals from the disclosed security system. Therefore the scanners do not interfere with the existing portal monitors that contain radiation detectors and X-ray scanners.

In other preferred embodiments an encrypted programmable and reprogrammable RFID tag that is affixed to, but preferably imbedded in goods, usually at the time of manufacture. The tag contains an identifying marker, such as an alphanumeric and symbologic identifier, which is unique to the specific item to which it is attached. For example, in a batch of women's dress shoes, each shoe (or perhaps pair of shoes) bears a tag with a unique, randomly assigned number. By itself, the number has no logic and conveys no information as to the shoe or anything about it. The data associated with the number is maintained in a central database. The data, which could include virtually anything, would be provided by the manufacturer and might include such things as the manufacturer, product information (style of shoe, model, color, material, date of manufacture, factory identity, SKU, etc.), sales information (purchase order no., purchaser, destination, routing, carrier, etc.), etc.

In still another embodiment, a reading device can decrypt the tag for its ID. The device can be a laser or antenna which can read the tag, which antenna or laser reader must be reprogrammable and be capable of reading a matrix of numbers, letters and symbols multi-directionally, with the ability to target certain symbols, letters or numbers (jumping from one to another) and extract the ID or any reading device that is able to do this. The tag is constructed such that it contains a unique marker code which is associated with the product, in which it is preferably imbedded to avoid tearing or compromising, rather than affixed thereto and, by the application of commercially practical encryption methods and devices, the marker is accessible only to authorized persons. Therefore, we use subject scanners and antennae.

In another embodiment, a dynamic communication exists between the reading device and the remotely maintained central database server by which useful information stored in the central database can determine whether the tag (and hence the object to which it is attached) is authentic. “Dynamic” is used in the sense that the reading device can more or less instantaneously access the data stored on the central database as it relates to the particular object.

In another embodiment, a limiting, feature of the reading device is that it employs a decryption methodology which is itself dynamic, where “dynamic” in this sense means that the protocol for reading the tag ID is a time dependent variable. The security system host is in total control of the variability of the protocol. This is a further barrier to those seeking to access information stored in the security system main database (the central database). For example, the ID information may be contained on a matrix of magnetic particles embedded in material on the tag.

At any given time the manner in which the reader device processes the information obtained is determined by a security system encryption random pattern. For example, a matrix of a 7×7 array of digits; at time=t1, the array is processed by ordering an equation in alphanumeric and symbologic 5D code (including two elements of quantum physics, randomness and time) which result will tell the scanner to read the contents of the shipment, the products it contains, when and where the products were made, the route it took to get to the geographical location where the tag is being read, taking into account the time and any random events applying to that particular product shipment and using the GPS Capability of RFID tell us whether that particular shipment containing the particular products that the tag says are supposed to be in that container is where it is supposed to be geographically or if it is a duplicate shipment number from a counterfeiter. At another time, t2, the array is processed by ordering a (for instance) code for a 12×12 matrix or 36 column×4 row rectangle, formed by randomly picking codes from the database and displaying said code by picking out letters, digits or symbols row by row from bottom to top, which code will give the same information as above. The determination of the processing is controlled by the host of the security system. Consequently, the ID is itself a time dependent identifier, because the programming at the database will change the code at random every few minutes. It acts as a key which points in the server to the correct data for the specific object in question. The central database controls who gets access to the data info information.

The method has several applications for use in Customs, Law Enforcement, Military, general transportation and many other applications.

The method's primary function when invented is its anti-counterfeit application not only for customs but it can also be used in a myriad other law enforcement and security applications. For example, Customs officials can now readily identify and intercept counterfeited goods simply by scanning a rail yard, sea port yard, etc. Customs officials can also scan an individual case of goods using a hand held reading device. The processing of the device is such that it reads the routing information and goods description from the security system's central database. If there is a discrepancy, an LED warning light, with sound, is triggered, signaling to the customs personnel that the goods are suspect. This could occur, for example, because the scanned goods are tested in Miami customs but the delivery information in the trans security system's central database for the ID number being read indicates that the goods are being shipped via Philadelphia. The goods therefore need to be inspected, because they are in the wrong place.

Another possible outcome would be if the reading device cannot access any data. This suggests that the tag is bogus, and the goods, therefore, are suspect. Of course, one must, in these cases, first establish that a security material exists and that the lack of data access is not merely because the shipping container does not have a security tag.

In another embodiment, the system can be used in inventory control. The function of the tags can act as passive global positioning (GPS) devices. Remote readers can pinpoint the location of a tag within a warehouse. This means that the warehouse operator does not have to keep tract of the location of goods (as, say, by aisle, tier and bin) but can place the goods in any available, convenient spot and find it by way of the GPS signal.

Because the scanners and proprietary codes are reprogrammable, others in the chain of ownership or interest in the goods can associate additional information with the goods. For example, the purchaser of the goods (say, the shipment of 200 gross pair of women's shoes), say Saks 5th Avenue, for its own inventory control purposes now adds information to the trans security system's central database, which indicates which of its stores received which of the shoes.

Security applications for the present invention include, but are not limited to, Automated Broker Interface (ABI) and Automated Commercial Environment System, AMS Automated Manifest System, Intelligence Driven and Random Anti-Counterfeit Targeting, Proprietary 5D Code and Barcode Symbology. The present invention will also serve as a valuable tool to all areas of the transportation industry, and will have application for the protection of intellectual property of virtually every sort that is contained in any tangible media upon which the security tags may be affixed.

In describing the invention, reference has been made to preferred embodiments and illustrative advantages of the invention. In particular, provision has been made for components, systems, and methods for dynamically tracking and verifying shipments of goods and materials in a controlled manner where only authorized entities have access. Those skilled in the art, and familiar with the instant disclosure of the subject invention, may recognize other additions, deletions, modifications, substitutions, and/or changes which will fall within the purview of the subject invention and claims.

What is claimed is:

1. A security component for use with a product in a trans-security system, said security component comprising:
a base member;
a radio frequency identification (RFID) tag connected to said base member, wherein said RFID tag comprises:
an RFID antenna; and
an RFID chip storing a first encrypted code for uniquely identifying said RFID tag;
a stock-keeping unit (SKU) tag connected to said base member, wherein said SKU tag has a second encrypted code for uniquely identifying said SKU tag, and wherein said SKU tag is readable by a laser; and
at least one of:
a third encrypted code imbedded within said base member, wherein said third encrypted code comprises printed characters; and
a hologram connected to said base member.

2. A security component for use with a product in a trans-security system as defined in claim 1, wherein:
said security component includes both of said third encrypted code and said hologram.

3. A security component for use with a product in a trans-security system as defined in claim 1, wherein:
said base member is formed from a first material, and wherein said RFID tag connected to said base member is imbedded within said base member such that said RFID tag is enrobed within said first material.

4. A security component for use with a product in a trans-security system as defined in claim 3, wherein:
said first material comprises a flexible material having a tensile strength of between 40 MPa and 50 MPa.

5. A security component for use with a product in a trans-security system as defined in claim 4, wherein:
said first material has a hardness of between 65 to 96 measured on a shore A hardness scale.

6. A security component for use with a product in a trans-security system as defined in claim 1, wherein:
said security component comprises said third encrypted code, and wherein said third encrypted code is formed by a particle material having a tensile strength greater than that of said first material.

7. A security component for use with a product in a trans-security system as defined in claim 1, wherein:
said first and second encrypted codes are encrypted according to distinct encryption algorithms.

8. A security component for use with a product in a trans-security system as defined in claim 7, wherein:
said security component is associated with an entry into a secure database, and
both of said second and third encrypted codes are required to access said entry into the secure database.

9. A security component for use with a product in a trans-security system as defined in claim 7, wherein:
at least one of said first, second, and third encrypted codes is a time-varying encrypted code.

10. A security component for use with a product in a trans-security system as defined in claim 1, wherein:
said security component uniquely identifies the product, and
said security component is attached to the product during manufacture of the product.

11. A security component for use with a product in a trans-security system as defined in claim 1, wherein:
said security component uniquely identifies the product, and
said security component is imbedded within the product during manufacture of the product.

12. A security component for use with a product in a trans-security system as defined in claim 1, wherein:
said base member is at least one of a thread, a tape, a strip, a patch, or a film, and
said RFID tag is imbedded within said base member.

13. A security component for use with a product in a trans-security system as defined in claim 12, wherein:
said base member is operable for mounting said base member at least one of onto the product or within the product.

14. A trans-security system for scanning and detecting shipments of unauthorized goods, said trans-security system comprising:
a security tag carrying encrypted information comprising:
a unique identifier; and
goods details including at least two of seller, manufacturer, buyer, model number, serial number, color, and size data;
shipping details including at least two of shipping location, shipping time delivery location, and delivery time data;
a central database storing information associated with each unique identifier with said goods details and said shipping details;
a decryption scanner comprising:
a memory for storing a decryption key received from said central database, wherein said decryption key is only valid for a discrete time period;
a communication link operative to receive said decryption key from said central database, to transmit information from said decryption scanner to said central database, and to receive a signal from said central database at said scanner location;
wherein said decryption scanner scans the shipment of goods, detects said security tag, reads the encrypted information on the security tag, decrypts the encrypted information if the encryption key is valid, and sends the decrypted information to the central database;
wherein said central database compares said decrypted information sent from the decryption scanner with said information associated with each unique identifier stored in the database and, if the comparison detects no inconsistency, sends a signal to said decryption scanner indicating that the shipment contains authorized goods and, if the comparison detects an inconsistency, sends a signal to said decryption scanner indicating that the shipment contains unauthorized goods.

15. A trans-security system for scanning and detecting shipments of unauthorized goods as defined in claim 14, wherein:
said security tag is embedded within a good.

16. A trans-security system for scanning and detecting shipments of unauthorized goods as defined in claim 14, wherein:
said security tag is affixed to a shipping container.

17. A trans-security system for scanning and detecting shipments of unauthorized goods as defined in claim 14, wherein:
said communication link allows only a one way flow of data from the scanner to the database and only information sent to the scanner location is the signal that the shipment contains authorized or unauthorized goods.

18. A trans-security system for scanning and detecting shipments of unauthorized goods as defined in claim 14, wherein:
said communication link is further operative to transmit said information associated with each unique identifier stored in the central database to law enforcement officials.

19. A trans-security system for scanning and detecting shipments of unauthorized goods as defined in claim 14, wherein:
said security tag is a bar code and said scanner is a bar code reader.

20. A trans-security system for scanning and detecting shipments of unauthorized goods as defined in claim 14, wherein:
said security tag is a radio frequency identification (RFID) tag and said decryption scanner is a RFID reader.

21. A trans-security system for scanning and detecting shipments of unauthorized goods as defined in claim 14, wherein:
said security tag is manufactured after an order for goods is placed with a manufacturer of the goods;
said security tag is affixed to a good while the good is manufactured; and
said goods details are transmitted to said central database after the security tag is affixed to the good.

22. A trans-security system for scanning and detecting shipments of unauthorized goods as defined in claim 14, wherein:
said scanning is done automatically

23. A trans-security system for scanning and detecting shipments of unauthorized goods as defined in claim 22, wherein:
said automatic scanning is done by portal monitors.

24. A method for authenticating shipments of authorized goods having encrypted tags connected thereto using a decryption scanner and a central server including a central database, the method comprising:
scanning a shipment of goods to detect encrypted tags associated with goods of the shipment of goods;
reading an encrypted code from a particular encrypted tag associated with a particular good of the shipment;
receiving a decryption key from the central server;
decrypting said encrypted code using said decryption key received from the central server to generate a decrypted code;
transmitting said decrypted code to the central server; and
in response to the transmitting said decrypted code to the central server, receiving from the central server an authentication signal indicating whether the shipment of goods is authenticated.

25. A method for authenticating shipments of authorized goods having encrypted tags connected thereto using a decryption scanner and a central server including a central database as defined in claim 24, the method further comprising:
receiving the decryption key which is valid for a limited period of time from the central server; and
decrypting said encrypted code using said decryption key during the limited period of time to generate a decrypted code.

26. A method for authenticating shipments of authorized goods having encrypted tags connected thereto using a decryption scanner and a central server including a central database as defined in claim 25, the method further comprising:
receiving the decryption key that is time-varying from the central server; and
decrypting said encrypted code using said time-varying decryption key to generate a decrypted code.

27. A method for authenticating shipments of authorized goods having encrypted tags connected thereto using a decryption scanner and a central server including a central database as defined in claim 24, the method further comprising:
reading a plurality of encrypted codes from a plurality of encrypted tags associated with goods of the shipment;
decrypting each encrypted code of the plurality of encrypted codes using said decryption key received from the central server to generate a plurality of decrypted codes;
transmitting each decrypted code of the plurality of decrypted codes to the central server; and
in response to the transmitting said plurality of decrypted codes to the central server, receiving from the central server an authentication signal indicating whether the shipment is authenticated or not.

28. A method for authenticating shipments of authorized goods having encrypted tags connected thereto using a decryption scanner and a central server including a central database as defined in claim 27, the method further comprising:
providing each encrypted tag of the plurality of encrypted tags with a plurality of encryption codes associated with each encrypted tag.

29. A method for authenticating shipments of authorized goods having encrypted tags connected thereto using a decryption scanner and a central server including a central database as defined in claim 24, the method further comprising:
transmitting identifying information associated with the decryption scanner to the central server at the same time as transmitting said decrypted code, wherein said identifying information includes at least one of a location of the decryption scanner, a unique identifier associated with the decryption scanner, a unique identifier associated with a current user of the decryption scanner, and a unique identifier of a facility within which the decryption scanner is currently used.

30. A method for authenticating shipments of authorized goods having encrypted tags connected thereto using a decryption scanner and a central server including a central database as defined in claim 24, the method further comprising:
performing said steps of scanning and reading using wireless communications.

31. A method for authenticating shipments of authorized goods having encrypted tags connected thereto using a decryption scanner and a central server including a central database as defined in claim 30, the method further comprising:
reading a second encrypted code associated with the particular good of the shipment using optical technology.

32. A method for authenticating shipments of authorized goods having encrypted tags connected thereto using a decryption scanner and a central server including a central database as defined in claim 24, the method further comprising:
performing at least one of said steps of scanning and reading optically.
